(19) United States
(12) Patent Application Publication
(10) Pub. No.: US 2011/0155073 A1
(43) Pub. Date: Jun. 30, 2011

(54) Aquarium combined with Cat Furniture

(76) Inventor: Patrick F. Kilroy, Lake Elsinore, CA (US)

(21) Appl. No.: 12/647,869

(22) Filed: Dec. 28, 2009

(51) Int. Cl. A01K 63/00; A01K 29/00

(52) U.S. Cl. 119/247; 119/28.5

(57) ABSTRACT

An aquarium combined with cat furniture comprising an aquarium full of water that is used to house aquatic animals and is supported on a platform, which is an integral part of cat furniture. The cat furniture is covered in carpeting or similar material. The cat furniture functions as both a platform to support the aquarium and to provide artificial cat habitat to facilitate such functional cat behaviors as climbing, clawing, hiding, stalking and sleeping. There can be a removable hood placed on top of the aquarium that is covered in similar material as the cat furniture and used as a perch for a cat. There can also be an air chamber display case submerged inside the aquarium that is in fluid communication with the atmosphere through a conduit that provides a passageway for a cat to travel from outside of the aquarium to the interior air chamber display case.

### BACKGROUND OF THE INVENTION

This invention pertains to an article of manufacture in the field of animal husbandry (Class 119), more specifically to the subclasses aquarium and combined aquarium. The present invention relates to the integration of an aquarium combined with cat furniture.

The domestic housecat likes to climb, claw, conceal, stalk and nap. The pet industry provides a wide array of artificial cat habitats to gratify these behaviors. The pet industry has various names for this type of cat furniture, including cat condos, cat tree houses, cat houses, cat gyms, cat towers, cat perches and cat scratching posts. For example, poles having platforms or decks upon which the cat can climb and perch, are illustrated in U.S. Pat. Nos. 3,479,991; 3,595,209; D370,093 and 4,497,279. Structures upon which cats can climb and sharpen their claws have also been illustrated in U.S. Pat. No. 4,112,873.

Anyone who has owned both a cat and an aquarium, knows that cats are instinctively drawn to the fish contained inside the aquarium. It is also known that occasionally curiosity can get a cat into trouble with the aquarium or the aquarium owner. Cats have been known to damage aquarium stands by scratching. Cats have been known to jump on top of aquarium hoods and use them as a stalking platforms or perches. Cats have been known to tip over aquariums. Cats have also been known to fall into aquariums.

It would be visually interesting to view a curious cat inside an aquarium, especially if the cat enjoys it. Prior art attempts at aquarium combinations that provide the illusion of viewing terrestrial animals existing underwater in an aquarium have failed to make the necessary provisions for a cat. For example, U.S. Pat. No. 296,853 to Ledig in 1884; U.S. Pat. No. 6,176,202 to Wood and U.S. Pat. No. 4,958,593 to Hurlburt, all purposefully confine the terrestrial animal being displayed within the bounds of the terrarium or inner air chamber as a living space. This type of design is inadequate in providing life support functions, such as food, water, cleaning and care for a cat. In addition, this type of design is unsuitable for maintaining the well being of a free roaming cat. The improvement needed to accommodate a housecat would utilize the inner air chamber as a temporary display case only and not as a living space. Allowing the cat unrestricted access to the air chamber display case would allow life support functions to be provided outside the confines of the air chamber.

People that desire to own both a cat and an aquarium may increase their enjoyment by viewing a combined aquatic and cat habitat. Prior art has failed to recognize the utility of a combining an aquarium with cat furniture.

It is an object of the present invention to encourage the behavioral antics of cats to the amusement of the pet owner by utilizing an integrated structure for both the cat furniture and aquarium.

It is a further object of the preferred embodiment of the invention to provide the illusion of viewing a cat existing underwater with aquatic animals, while simultaneously providing for ready access to the aquatic animals for the pet owner and unrestricted access to an inner air chamber display case applied to the aquarium for displaying a cat.

These and other objects of the present invention will become better understood from the detailed description which follows.

### BRIEF SUMMARY OF THE INVENTION

The present invention solves the problems of prior art by utilizing a novel design for an aquarium combined with cat furniture. The preferred embodiment of the present invention comprises a substantially transparent aquarium full of water. Contained inside the aquarium is a smaller, completely submerged, substantially transparent, inner air chamber display case connected to the bottom floor of the aquarium and is water tight. The aquarium is used to house and display aquatic animals, such as fish. At least one vertical wall of the aquarium and air chamber display case are further joined by a substantially transparent horizontal conduit, said conduit being in fluid communication with the atmosphere. The air chamber display case is used to display a cat. The cat is permitted access to the air chamber display case by entering an opening in an external wall of the aquarium and moving through the conduit, then through an opening in the wall of the air chamber display case.

The aquarium is supported on a platform, which is an integral part of cat furniture. The cat furniture is designed to function as both a platform for the aquarium and to provide artificial cat habitat to facilitate such functional cat behaviors as climbing, clawing, hiding, stalking and sleeping.

### BRIEF DESCRIPTION OF THE SEVERAL VIEWS OF THE DRAWING

FIG. 1 is a perspective view of the subject invention;

FIG. 2 is a front view of FIG. 1;

FIG. 3 is a perspective view of FIG. 1 showing the cabinet and hood doors in the open position;

FIG. 4 is a rear view of FIG. 1;

FIG. 5 is a side view of FIG. 1;

FIG. 6 is a perspective view of another preferred embodiment of the subject invention, and

FIG. 7 is a rear view FIG. 6.

### DETAILED DESCRIPTION OF THE INVENTION

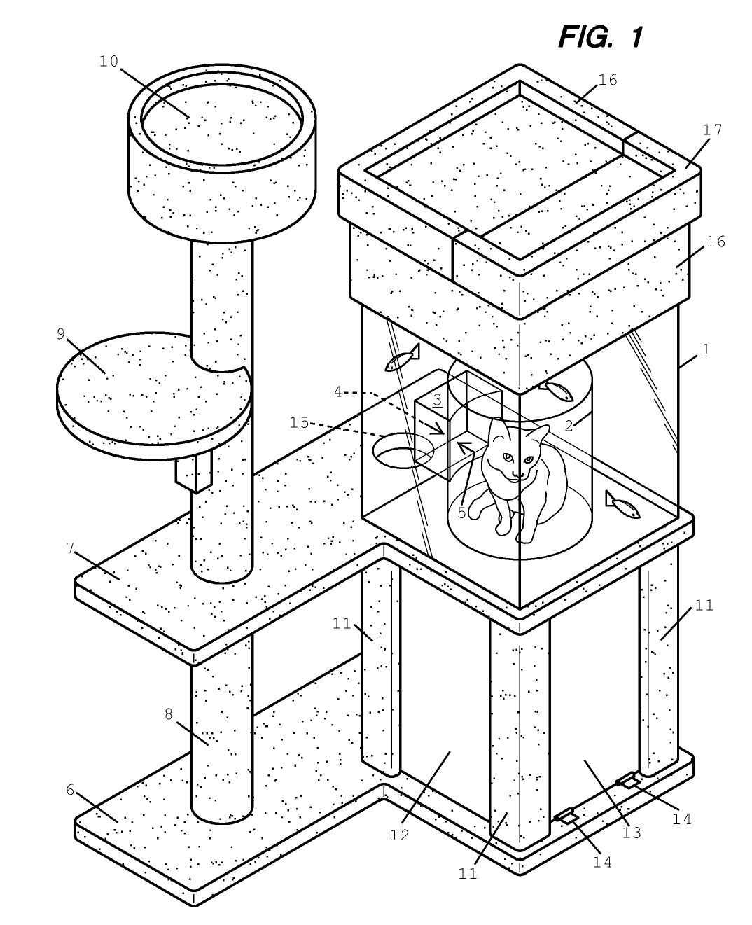

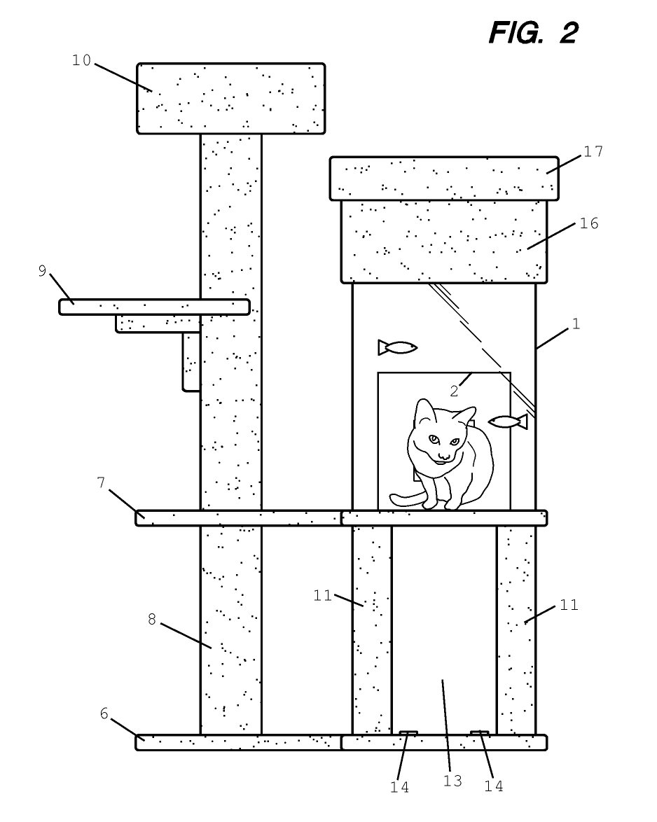

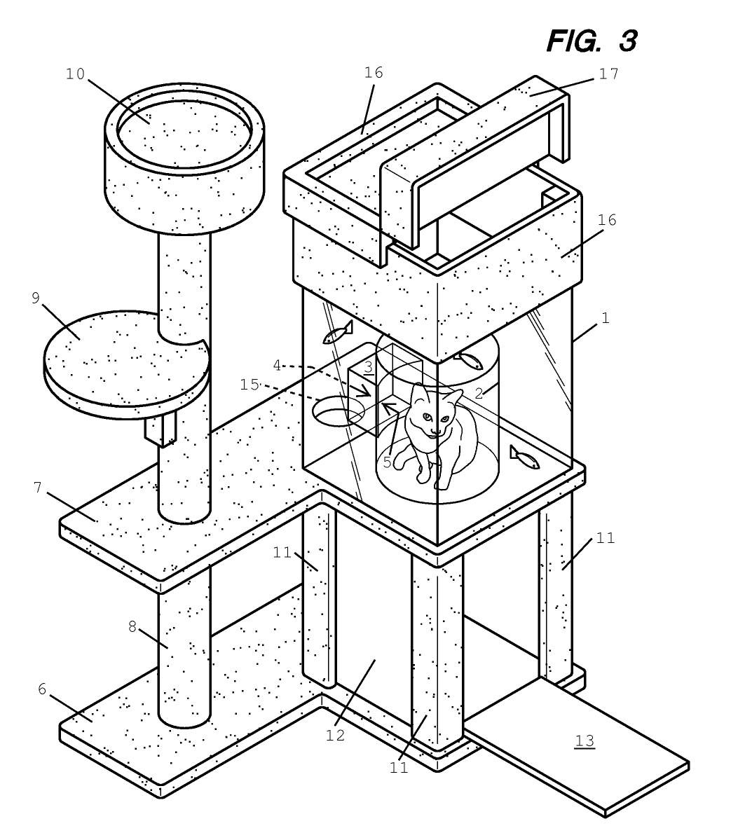

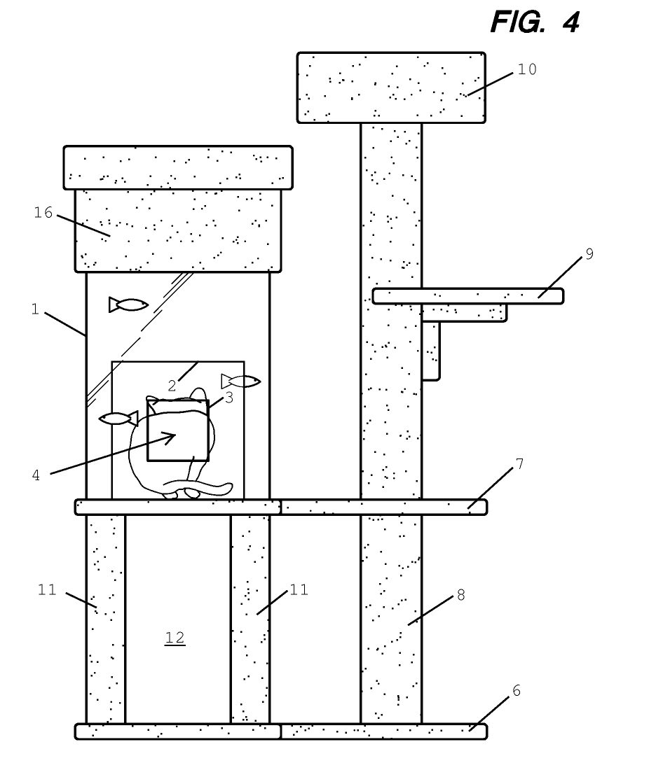

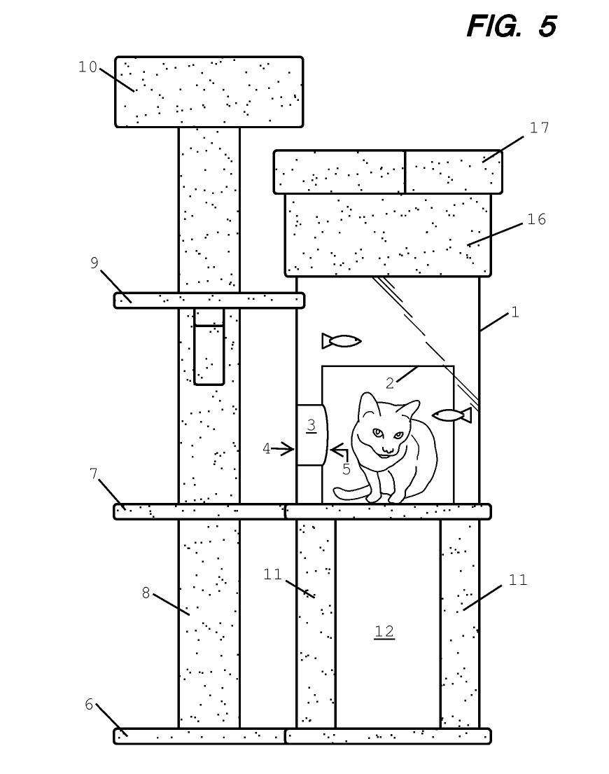

The preferred embodiment of the present invention comprises an aquarium combination combined with cat furniture. With reference to the drawings and particularly FIGS. 1, 2, 3, 4 and 5, the aquarium 1 is made of substantially transparent plastic or glass material. The aquarium 1 is made of one or more substantially vertical wall(s). The wall(s) and a bottom floor part are connected by adhesive to form the aquarium 1. The top of the aquarium 1 is substantially open; however, the upper edge of the wall(s) may be additionally joined by a frame, as is known in the aquarium industry. The aquarium 1 is made to be completed filled with water and house aquatic animals.

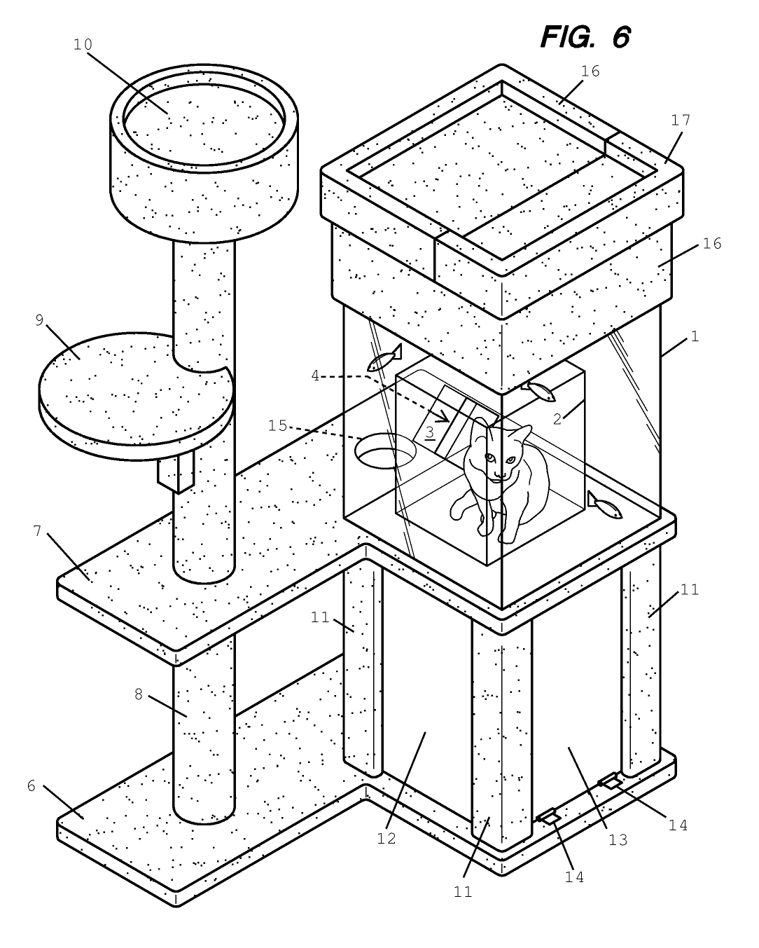

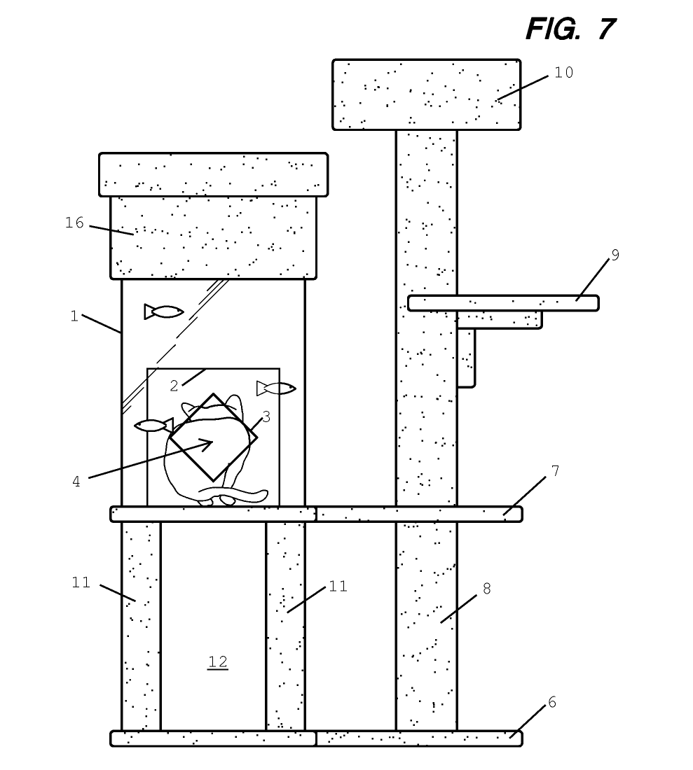

Inside the aquarium 1 is an air chamber display case 2 made of substantially transparent plastic or glass material. The air chamber display case 2 is made of one or more substantially vertical wall(s). The wall(s) may be curved, as shown, or straight as shown in FIGS. 6 and 7. The top of the air chamber display case 2 is closed by a top part. The wall part(s) and top part are connected by adhesive and sealed to the bottom floor of the aquarium 1, thus forming the air chamber display case 2.

The dimensions of the air chamber display case 2 are smaller than the aquarium 1, thereby creating a space for housing aquatic animals, such as fish. The air chamber display case 2 is completely submerged underwater to allow aquatic animals to move over the top. A space is maintained between the air chamber display case 2 and interior wall(s) of the aquarium 1, which allow aquatic animals room to move around all sides of the air chamber display case 2.

At least one wall of the aquarium 1 and air chamber display case 2 are further joined by adhesive to a conduit 3. The conduit 3 is made of substantially transparent plastic or glass material. The conduit 3 is made of one or more horizontal part(s) joined by adhesive. The conduit 3 is in fluid communication with the atmosphere. An access opening 4 in the wall of the aquarium 1 is aligned with an access opening 5 in the wall of the air chamber display case 2 and joined to the conduit 3 to form a water tight connection. The access openings, 4 & 5, are coextensive within the bounds of the conduit 3. The air chamber display case 2 is used to display a cat. A cat is permitted ready access to the air chamber display case 2 by entering the access opening 4 in the wall of the aquarium 1 and moving through the conduit 3, then through the access opening 5 in the wall of the air chamber display case 2.

The aquarium is supported on a platform, which is an integral part of cat furniture. The frame of the cat furniture is made of wood. The frame is substantially covered by carpeting or similar material. The frame for the cat furniture is comprised of a base 6 with a plurality of vertical members 11 connected to and supporting a platform 7. Connected to the base 6 and passing through the platform 7 is a vertical post 8. One or more horizontal decks 9 and perches 10 may be attached to the post 8. The space created between the base 6 and platform 7 that is supported by vertical members 11 may be enclosed by walls 12 to form an enclosed cabinet. Access to the inside of the cabinet is provided by a door 13 that is hinged 14. The platform 7 may have a plurality of access openings 15 to allow a cat to travel through.

A removable hood 16 is provided for the top of the aquarium 1. The hood 16 is made of wood and substantially covered by carpeting or similar material. The top of the hood provides a perch location for a cat. The hood is made of one or more substantially vertical wall(s) and joined to a top part that partially encloses the hood. A hinged door 17 is provided on the hood 16 to provide ready access to the top of the aquarium 1 to facilitate maintenance.

FIGS. 6 and 7 show another preferred embodiment of the subject invention. In these drawings, the air chamber display case 2 is rectangular and the conduit 3 is shown in a diamond shape.

The above presents a description of the best mode contemplated of carrying out the present invention, and of the manner and process of making and using it, in such full, clear, concise, and exact terms as to enable a person skilled in the art to which it pertains to make and use this invention. This invention is, however, susceptible to modifications and alternate construction from that discussed above which are fully equivalent. For example, the wall(s) of the aquarium or air chamber display case may be straight or curved, thus taking on the geometric shapes referenced in the aquarium industry as a rectangle, pentagon, hexagon, bow front, cubed, cylinder and corner round. In addition, the conduit may be rectangular, cylindrical, diamond, or triangularly shaped. Alternatively, access to the air chamber display case could be from the bottom of the aquarium or the air chamber display case could share a common wall with the aquarium, thus eliminating the need for a conduit. Furthermore, the cat furniture could be made of material other than wood, such as plastic, metal or a combination of these materials. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention.

What I claim as my invention is:

1. An article of manufacture comprising:
a. a substantially transparent aquarium full of water that is used to house aquatic animals;
b. the aquarium is supported on top of a platform, which is an integral part of cat furniture;
c. the frame of said cat furniture comprising a base connected to a plurality of vertical members supporting said platform for the aquarium, a vertical post is connected to said base and passes through and extends above said platform, decks and perches may be connected to said vertical post;
d. the top of the aquarium is covered by a removable hood and provides a perch for a cat;
e. the surface of said frame for the cat furniture and the hood are substantially covered by carpeting or similar material; and
f. said cat furniture and the hood are utilized to facilitate such functional cat behaviors as climbing, clawing, hiding, stalking and sleeping.

2. Said aquarium of claim 1 is made from substantially transparent plastic or glass material.

3. The walls of the aquarium of claim 1 may be straight or curved to form the many geometric shapes commonly referenced by the aquarium industry as rectangle, pentagon, hexagon, bow front, cubed, cylinder and corner round.

4. Said frame for the cat furniture of claim 1 is made from wood, metal, plastic or a combination of these materials.

5. An article of manufacture comprising:
a. a substantially transparent aquarium full of water that is used to house aquatic animals;
b. contained inside the aquarium is a completely submerged, substantially transparent air chamber display case used to display a cat;
c. an access opening in the wall of the aquarium is aligned with an access opening in the wall of the air chamber display case and joined to a conduit to form a water tight connection, said conduit and the air chamber display case are in fluid communication with the atmosphere;
d. a cat is permitted ready access to the air chamber display case by entering said access opening in the wall of the aquarium and moving through said conduit, then through said access opening in the wall of the air chamber display case;
e. the aquarium is supported on top of a platform, which is an integral part of cat furniture;
f. the frame of said cat furniture comprising a base connected to a plurality of vertical members supporting said platform for the aquarium, a vertical post is connected to said base and passes through and extends above said platform, decks and perches may be connected to said vertical post;
g. the top of the aquarium is covered by a removable hood and provides a perch for a cat;
h. the surface of said frame for the cat furniture and the hood are substantially covered by carpeting or similar material; and
i. said cat furniture and the hood are utilized to facilitate such functional cat behaviors as climbing, clawing, hiding, stalking and sleeping.

6. Said aquarium of claim 5 is made from substantially transparent plastic or glass material.

7. The walls of the aquarium of claim 5 maybe straight or curved to form the many geometric shapes commonly referenced by the aquarium industry as rectangle, pentagon, hexagon, bow front, cubed, cylinder and corner round.

8. The walls of the air chamber display case of claim 5 may maybe straight or curved to form many geometric shapes.

9. The conduit of claim 5 may be rectangular, cylindrical, diamond, or triangularly shaped.

10. Said frame for the cat furniture of claim 5 is made from wood, metal, plastic or a combination of these materials.
